(19) United States
(12) Patent Application Publication
(10) Pub. No.: US 2026/0037578 A1
(43) Pub. Date: Feb. 5, 2026

(54) GRAPH DATA PROCESSING METHOD AND APPARATUS, AND GRAPH DATABASE-BASED DATA PROCESSING METHOD AND APPARATUS

(71) Applicant: Alipay (Hangzhou) Information Technology Co., Ltd., Hangzhou (CN)

(72) Inventor: Qi ZHANG, Hangzhou (CN)

(21) Appl. No.: 19/280,101

(22) Filed: Jul. 25, 2025

(30) Foreign Application Priority Data
Jul. 30, 2024 (CN) 202411031072.2

(51) Int. Cl. G06F 16/901; G06F 16/21

(52) U.S. Cl. CPC G06F 16/9024; G06F 16/211

(57) ABSTRACT

Embodiments of this specification provide a graph data processing method and apparatus, and a graph database-based data processing method and apparatus. In the graph data processing method, graph data represented in a data object form is obtained, where the graph data includes type values and attribute values of point and edge data; corresponding schemas are queried based on the type values of the graph data to determine a number of attribute byte groups corresponding to the type values, where the schemas are used to indicate attributes of the point and edge data, and each attribute byte group is used to store an attribute value of a corresponding attribute; convert the attribute values of the graph data into binary forms; and store the attribute values of the graph data that are represented in the binary forms-according to a byte group sequence format that matches the number of determined attribute byte groups.

### TECHNICAL FIELD

Embodiments of this specification generally relate to the field of computer technologies, and in particular, to a graph data processing method and apparatus, and a graph database-based data processing method and apparatus.

### BACKGROUND

As graph data is increasingly widely applied, graph database technologies and graph computing engine technologies have also rapidly developed. However, as a scale of the graph data becomes larger, performance of distributed graph computing engines in computing scenarios are often limited by data shuffle overheads and IO overheads. Therefore, how to effectively reduce data shuffle overheads and IO overheads to improve performance of distributed graph computing engines is of great significance.

### SUMMARY

In view of the above descriptions, embodiments of this specification provide a graph data processing method and apparatus, and a graph database-based data processing method and apparatus. By using the methods and the apparatuses, a binary coding scheme for graph data is implemented, and it helps efficiently read corresponding attribute values of the graph data.

According to an aspect of the embodiments of this specification, a graph data processing method is provided, including: obtaining graph data represented in a data object form, where the graph data includes type values and attribute values of point and edge data; querying corresponding schemas based on the type values to determine a number of attribute byte groups corresponding to the type values, where the schemas are used to indicate attributes of the point and edge data, and each attribute byte group is used to store an attribute value of a corresponding attribute; converting the attribute values of the graph data into binary forms; and storing the attribute values of the graph data that are represented in the binary forms according to a byte group sequence format that matches the number of determined attribute byte groups.

According to another aspect of the embodiments of this specification, a graph database-based data processing method is provided, including: converting an operation statement for a graph database into a corresponding execution plan, where each piece of graph data in the graph database is stored according to a byte group sequence format that matches the graph data, the byte group sequence format is used to indicate an organization manner of attribute values of the stored graph data, and the attribute values of the graph data are represented in binary forms; and executing the execution plan to obtain an operation result corresponding to the operation statement.

According to still another aspect of the embodiments of this specification, a graph data processing apparatus is provided, including: a data acquisition unit, configured to obtain graph data represented in a data object form, where the graph data includes type values and attribute values of point and edge data; a schema matching unit, configured to query corresponding schemas based on the type values to determine a number of attribute byte groups corresponding to the type values, where the schemas are used to indicate attributes of the point and edge data, and each attribute byte group is used to store an attribute value of a corresponding attribute; a value conversion unit, configured to convert the attribute values of the graph data into binary forms; and a data storage unit, configured to store the graph data represented in the binary forms according to a byte group sequence format that matches the number of determined attribute byte groups.

According to yet another aspect of the embodiments of this specification, a graph database-based data processing apparatus is provided, including: a plan generation unit, configured to convert an operation statement for a graph database into a corresponding execution plan, where each piece of graph data in the graph database is stored according to a byte group sequence format that matches the graph data, the byte group sequence format is used to indicate an organization manner of attribute values of the stored graph data, and the attribute values of the graph data are represented in binary forms; and a plan execution unit, configured to execute the execution plan to obtain an operation result corresponding to the operation statement.

According to another aspect of the embodiments of this specification, a graph data processing apparatus is provided, including at least one processor and a storage coupled to the at least one processor. The storage stores instructions. When the instructions are executed by the at least one processor, the at least one processor is enabled to perform the graph data processing method described above.

According to another aspect of the embodiments of this specification, a graph database-based data processing apparatus is provided, including at least one processor and a storage coupled to the at least one processor. The storage stores instructions. When the instructions are executed by the at least one processor, the at least one processor is enabled to perform the graph database-based data processing method described above.

According to another aspect of the embodiments of this specification, a computer readable storage medium is provided. The computer readable storage medium stores a computer program. When the computer program is executed by a processor, the graph data processing method and/or the graph database-based data processing method described above are/is implemented.

According to another aspect of the embodiments of this specification, a computer program product is provided, including a computer program. The computer program is executed by a processor to implement the graph data processing method and/or the graph database-based data processing method described above.

### BRIEF DESCRIPTION OF DRAWINGS

A further understanding of the essence and advantages of the content of this specification can be implemented with reference to the following accompanying drawings. In the accompanying drawings, similar components or features can have the same reference numerals.

FIG. 1 illustrates an example architecture of a graph data processing method and apparatus, and a graph database-based data processing method and apparatus according to an embodiment of this specification.

FIG. 2 is a flowchart illustrating an example of a graph data processing method according to an embodiment of this specification.

FIG. 3 is a flowchart illustrating another example of a graph data processing method according to an embodiment of this specification.

FIG. 4 is a schematic diagram illustrating an example of a byte group sequence format according to an embodiment of this specification.

FIG. 5 is a flowchart illustrating an example of a graph database-based data processing method according to an embodiment of this specification.

FIG. 6 is a flowchart illustrating an example of an execution process of an execution plan according to an embodiment of this specification.

FIG. 7 is a block diagram illustrating an example of a graph data processing apparatus according to an embodiment of this specification.

FIG. 8 is a block diagram illustrating another example of a graph data processing apparatus according to an embodiment of this specification.

FIG. 9 is a block diagram illustrating an example of a graph database-based data processing apparatus according to an embodiment of this specification.

FIG. 10 is a schematic diagram illustrating an example of a graph data processing apparatus according to an embodiment of this specification.

FIG. 11 is a schematic diagram illustrating an example of a graph database-based data processing apparatus according to an embodiment of this specification.

### DESCRIPTION OF EMBODIMENTS

The subject matter described in this specification is discussed below with reference to example implementations. It should be understood that these implementations are merely discussed to enable a person skilled in the art to better understand and implement the subject matter described in this specification, and are not intended to limit the protection scope, applicability, or examples described in the claims. The functions and arrangements of the discussed elements can be changed without departing from the protection scope of the content of the embodiments of this specification. Various processes or components can be omitted, replaced, or added in the examples based on a need. In addition, features described for some examples can alternatively be combined in other examples.

As used in this specification, the term “include” and variants thereof indicate open terms, meaning “including but not limited to”. The term “based on” means “at least partially based on”. The terms “one embodiment” and “an embodiment” indicate “at least one embodiment”. The term “another embodiment” means “at least one other embodiment”. The terms “first”, “second”, etc. can indicate different objects or the same object. The following can include other definitions, whether explicit or implicit. Unless explicitly stated in the context, the definition of a term is consistent throughout this specification.

A graph data processing method and apparatus, and a graph database-based data processing method and apparatus according to embodiments of this specification are described below in detail with reference to the accompanying drawings.

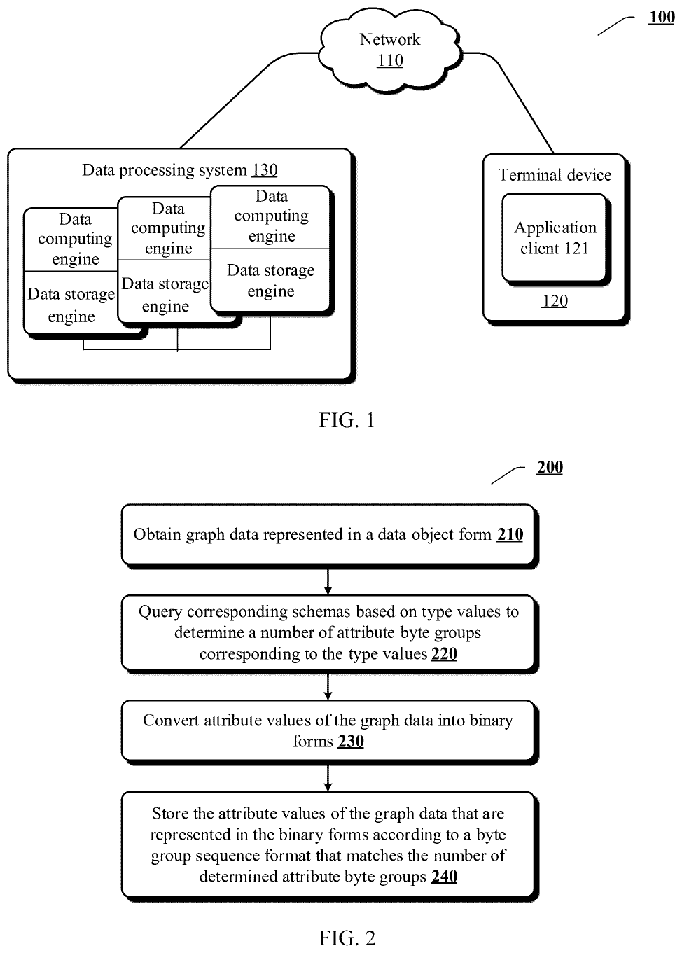

FIG. 1 illustrates example architecture 100 of a graph data processing method and apparatus, and a graph database-based data processing method and apparatus according to an embodiment of this specification.

In FIG. 1, network 110 is applied to an interconnection between terminal device 120 and data processing system 130.

Network 110 can be any type of network that can interconnect network entities. Network 110 can be a single network or a combination of various networks. In terms of a coverage area, network 110 can be a local area network (LAN), a wide area network (WAN), etc. In terms of a bearer medium, network 110 can be a wired network, a wireless network, etc. In terms of a data exchange technology, network 110 can be a circuit switched network, a packet switched network, etc.

Terminal device 120 can be any type of electronic computing device that can be connected to network 110, access a server or website on network 110, and process data, signals, etc. For example, terminal device 120 can be a desktop computer, a notebook computer, a tablet computer, a smartphone, etc. Although only one terminal device is shown in FIG. 1, it should be understood that different quantities of terminal devices can be connected to network 110.

In an implementation, terminal device 120 can be used by a user. Terminal device 120 can include an application client (for example, application client 121) that can provide various services for the user. In some cases, application client 121 can interact with data processing system 130. For example, application client 121 can transmit a message input by the user to data processing system 130, and receive a response associated with the message from data processing system 130. In this specification, “message” can be any input information, such as graph data to be imported, or a query statement for a graph database.

Data processing system 130 can provide various data processing services involving graph data, such as writing, modification, reading, query, and computing of the graph data. Data processing system 130 can be a stand-alone system, or can be a distributed system. In an implementation, the distributed data processing system can include multiple nodes. In some examples, each node can include a data computing engine and a data storage engine. The data computing engine can be configured to process various types of computing logic. The data storage engine can perform query or updating based on stored graph data, for computing use. In some examples, graph data can be stored at a storage layer of each node. In some examples, the storage layer of each node can be further configured to store data generated in a computing process.

It should be understood that all the network entities shown in FIG. 1 are examples. Based on a specific application need, architecture 100 can involve any other network entity.

FIG. 2 is a flowchart illustrating an example of graph data processing method 200 according to an embodiment of this specification.

As shown in FIG. 2, in 210, graph data represented in a data object form is obtained.

In this embodiment, a graph can include points and edges. The points in the graph can have respective type values and attribute values, to form point data. Similarly, the edges in the graph can also have respective type values and attribute values, to form edge data. In this embodiment, the type values can be used to indicate types to which the points or the edges belong, and the attribute values can be used to reflect various attributes of the points or the edges. It can be understood that the point or the edge each can have multiple attributes. In some examples, the type value and the attribute value can be represented as “type name: type value” and “attribute name: attribute value” respectively.

In this embodiment, the graph data can be represented in the data object form. In some examples, the point data and the edge data can be represented in a Java object form. Point data or edge data in the Java object form has an object header (Header) in addition to an attribute value. However, the object header often additionally causes a large amount of memory overheads in a data processing process.

In 220, corresponding schemas are queried based on type values to determine a number of attribute byte groups corresponding to the type values.

In this embodiment, correspondences between type values and schemas (schema) can be preset. The schemas can be used to indicate attributes of the point and edge data. Each attribute byte group can be used to store an attribute value of a corresponding attribute. In some examples, the graph can include a point of a user type, a point of a commodity type, an edge of a similar type, and an edge of an approved type. The edge of the similar type can be used to indicate whether a point of the user type is similar to a point of the user type, or can be used to indicate whether a point of the commodity type is similar to a point of the commodity type. The edge of the approved type can be used to indicate whether a point of the user type has a positive response to a point of the commodity type (for example, a user has purchased, praised, collected, or recommended a commodity). In an example, a schema corresponding to the point of the user type can be used to indicate various attributes of the point of the user type, such as a user identifier, an age, and a location. Correspondingly, a number of attribute byte groups corresponding to the point of the user type can be respectively used to store the user identifier, the age, the location, etc. A schema corresponding to the point of the commodity type can be used to indicate various attributes of the point of the commodity type, such as a commodity identifier, a category, a brand, and a price. Correspondingly, a number of attribute byte groups corresponding to the point of the commodity type can be respectively used to store the commodity identifier, the category, the brand, the price, etc.

In some implementations, the above schemas are further used to indicate data type needs of the attributes for corresponding attribute values. In some examples, data type needs of the attributes such as the user identifier, the age, and the location of the point of the user type for corresponding attribute values can be respectively Vid (which can be, for example, a fixed-length character string or INT64), int (an integer type), string (a character string type), etc. Data type needs of the attributes such as the commodity identifier, the category, the brand, and the price of the point of the commodity type for corresponding attribute values can be respectively Vid, string, string, int, etc. A data type need of a similarity attribute of the edge of the similarity type for a corresponding attribute value can be double (a double-precision floating-point type).

In some implementations, the schemas corresponding to the type values have schema identifiers. In these examples, the schema identifiers are used to distinguish between different schemas. In some examples, specific information of the schemas can be obtained based on the schema identifiers.

In 230, the attribute values of the graph data are converted into binary forms.

In some examples, for a numeric attribute value of the graph data, the numeric attribute value can be directly converted into a corresponding binary code. For a non-numeric attribute value of the graph data, the non-numeric attribute value can be converted into a corresponding binary code through ASCII coding, GB2312 coding, Unicode coding, etc.

In 240, the attribute values of the graph data that are represented in the binary forms are stored according to a byte group sequence format that matches the number of determined attribute byte groups.

In this embodiment, the above byte group sequence format can be used to indicate to store the attribute values of the graph data in corresponding attribute byte groups. In some examples, the matched byte group sequence format can include at least a predetermined quantity of attribute byte groups, and each attribute byte group is configured to store an attribute value of a corresponding attribute. In some examples, the above predetermined quantity can be the same as a quantity of the above number of determined attribute byte groups, i.e. the matched byte group sequence format can be a combination of the number of determined attribute byte groups. Then, the attribute values represented in the binary forms can be stored in the corresponding attribute byte groups. Therefore, an attribute value of a specified attribute can be correspondingly obtained based on locations of the byte groups corresponding to the attributes in the byte group sequence format.

In some implementations, the byte group sequence format that matches the number of determined attribute byte groups can be constructed in the following manner: constructing the byte group sequence format that matches the number of determined attribute byte groups based on a combination of a null value determining byte group and the number of attribute byte groups. Data stored in the null value determining byte group can be used to indicate whether data stored in the number of attribute byte groups is null (Null). In some examples, a quantity of bits in the data in the null value determining byte group in the byte group sequence format can be equal to the quantity of attribute byte groups, so that a value (for example, 0 or 1) of each bit in the null value determining byte group can be used to indicate whether data stored in a corresponding attribute byte group is null. In some examples, when the graph data stored in the byte group sequence format is read, the data in the null value determining byte group can be first read, and then corresponding data can be read from an attribute byte group that has a non-null attribute value and that is indicated by the above data. Therefore, data reading efficiency can be improved.

In some implementations, after the byte group sequence format that matches the number of determined attribute byte groups is constructed, the attribute values of the graph data that are represented in the binary forms can be first stored in the corresponding attribute byte groups in the byte group sequence format; then values (for example, 0 or 1) of the data stored in the null value determining byte group in the byte group sequence format can be determined based on data stored in the attribute byte groups in the byte group sequence format; and the determined values can be stored in the corresponding null value determining byte group.

In some implementations, the byte group sequence format that matches the number of determined attribute byte groups can be constructed in the following manner: constructing, based on a data type need corresponding to each attribute byte group in the number of attribute byte groups, a unit byte group that matches the data type need; and constructing the byte group sequence format that matches the number of determined attribute byte groups based on a combination of constructed unit byte groups.

Based on the above implementation, the unit byte group can include at least one of a first data type byte group and a second data type byte group. In some examples, if the data type need corresponding to the attribute byte group indicates that an attribute value belongs to a first data type, the first data type byte group can be constructed. The first data type byte group can be used to store an attribute value that belongs to the first data type in the graph data. If the data type need corresponding to the attribute byte group indicates that an attribute value belongs to a second data type, the second data type byte group can be constructed. The second data type byte group can be used to store storage location information of an attribute value that belongs to the second data type in the graph data. In some examples, the first data type can be a data type whose data is suitable for being directly stored in a specified-length byte group, for example, a basic data type, such as int, long, or boolean (a Boolean type). For another example, the first data type can be a relatively short fixed-length data type, such as a relatively short array (array). The second data type can be a data type other than the above first data type, for example, can be a relatively long fixed-length data type, for example, a relatively long array. For another example, the second data type can be a variable-length data type, such as a list (list) type or an arraylist (an array that can be dynamically modified in Java) type, or can be a complex data type, for example, a data value is point data or edge data.

In some examples, if the constructed unit byte groups include second data type byte groups, the byte group sequence format that matches the number of determined attribute byte groups can be constructed based on a combination of the constructed unit byte groups and an extended byte group. The extended byte group can be used to store attribute values that belong to the second data type in the graph data based on storage location information of the attribute values. In these implementations, the attribute values that belong to the second data type can be stored in specified locations in the extended byte group, and attribute value storage location information used to indicate the above storage locations of the attribute values are stored in the second data type byte groups corresponding to the attribute values.

In some implementations, first data type byte groups and second data type byte groups can have the same length. In some examples, a length can be pre-specified. For example, the first data type byte groups and the second data type byte groups each can be set to 8 bytes. In some examples, alignment can be performed based on a quantity of bytes occupied by the longest byte group in the first data type byte groups and the second data type byte groups, i.e. lengths of the first data type byte groups and the second data type byte groups are set to the quantity of bytes occupied by the longest byte group. An arrangement order of the first data type byte groups and the second data type byte groups can be determined based on a sequence of the attributes indicated by the schemas. In some examples, the arrangement order of the first data type byte groups and the second data type byte groups can be consistent with the sequence of the attributes indicated by the above schemas. It can be understood that, the first data type byte groups and the second data type byte groups can be arranged in an interleaved manner according to the sequence of the attributes indicated by the schemas. For example, if the sequence of the attributes indicated by the schemas is: attribute A (corresponding to the first data type), attribute B (corresponding to the first data type), attribute C (corresponding to the second data type), and attribute D (corresponding to the first data type), an arrangement sequence of the byte groups in the corresponding byte group sequence format can be: a first data type byte group corresponding to attribute A, a first data type byte group corresponding to attribute B, a second data type byte group corresponding to attribute C, a first data type byte group corresponding to attribute D, and the extended byte group. Therefore, an attribute value of a specified attribute can be correspondingly obtained based on only the sequence of the attributes indicated by the schemas and the uniform length occupied by the first data type byte groups and the second data type byte groups, without additionally knowing locations of the byte groups corresponding to the attributes in the byte group sequence format.

In some implementations, the byte group sequence format that matches the number of determined attribute byte groups can be constructed in the following manner: constructing the byte group sequence format that matches the number of determined attribute byte groups based on a combination of a schema identifier byte group and the number of attribute byte groups. Data (schema identifiers) stored in the schema identifier byte group can be used to indicate schemas used as a generation basis of the byte group sequence format. In some examples, the above matched byte group sequence format can be constructed based on the combination of the schema identifier byte group and the attribute byte groups.

In some implementations, after the byte group sequence format that matches the number of determined attribute byte groups is constructed, the schema identifiers can be stored in the schema identifier byte group in the byte group sequence format; and the attribute values of the graph data that are represented in the binary forms can be stored in the corresponding attribute byte groups in the byte group sequence format. Therefore, each piece of graph data stored in a corresponding byte group sequence format can carry schema information that the byte group sequence format is based on. In the above manner, the data stored in the schema identifier byte group can be used to indicate schemas that the graph data is stored based on. Even if a subsequent operation involves modification of the schemas, schemas that decoding should be based on can be known based on this, thereby avoiding a read failure caused by a mismatch between modified schemas and a storage format of the graph data.

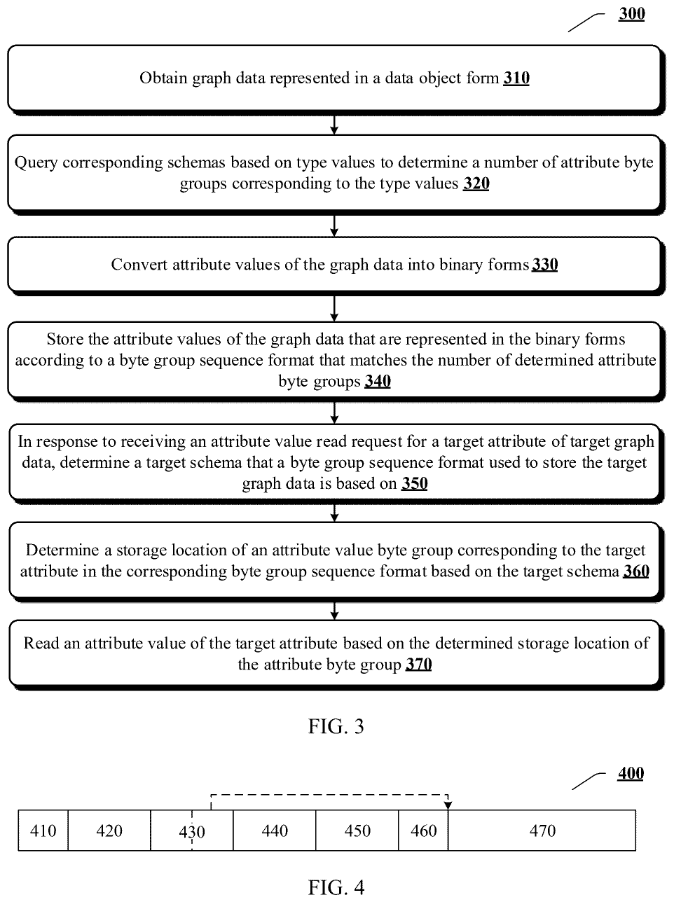

FIG. 3 is a flowchart illustrating another example of graph data processing method 300 according to an embodiment of this specification.

In 310, graph data represented in a data object form is obtained.

In 320, corresponding schemas are queried based on type values to determine a number of attribute byte groups corresponding to the type values.

In this embodiment, the schemas can be used to indicate attributes of point and edge data and data type needs of the attributes for corresponding attribute values.

In 330, attribute values of the graph data are converted into binary forms.

In 340, the attribute values of the graph data that are represented in the binary forms are stored according to a byte group sequence format that matches the number of determined attribute byte groups.

In this embodiment, the byte group sequence format can be used to indicate to store the attribute values of the graph data in corresponding byte groups. The byte group sequence format that matches the number of determined attribute byte groups is constructed in the following manner: if a data type need corresponding to an attribute byte group indicates that an attribute value belongs to a first data type, constructing a first data type byte group, where the first data type byte group is used to store an attribute value that belongs to the first data type in the graph data; or if a data type need corresponding to an attribute byte group indicates that an attribute value belongs to a second data type, constructing a second data type byte group, where the second data type byte group is used to store storage location information of an attribute value that belongs to the second data type in the graph data, first data type byte groups and second data type byte groups have the same length, and an arrangement order of the first data type byte groups and the second data type byte groups is determined based on a sequence of the attributes indicated by the schemas; and constructing the byte group sequence format that matches the number of determined attribute byte groups based on a combination of at least one of the constructed first data type byte groups and second data type byte groups.

It should be noted that for specific operations of the above steps 310 to 340, references can be made to the corresponding descriptions in step 210 to step 240 in the above embodiment in FIG. 2. Details are omitted here for simplicity.

In 350, in response to receiving an attribute value read request for a target attribute of target graph data, a target schema that a byte group sequence format used to store the target graph data is based on is determined.

In some examples, a schema corresponding to the target attribute of the target graph data targeted by the attribute value read request can be determined as the target schema. In some examples, relationships between byte group sequence formats of graph data and schemas that the byte group sequence formats are based on can be pre-stored.

In some implementations, the graph data stored in the byte group sequence format further includes schema identifiers used to indicate schemas used as a generation basis of the byte group sequence format. The target schema can be determined from a schema library based on the schema identifiers. In some examples, the schema library can record specific information of various schemas and corresponding schema identifiers.

In 360, a storage location of an attribute value byte group corresponding to the target attribute in the corresponding byte group sequence format is determined based on the target schema.

In this embodiment, because an arrangement order of first data type byte groups and second data type byte groups can be determined based on a sequence of attributes indicated by the target schema, a storage location of an attribute value corresponding to the target attribute in the corresponding byte group sequence format can be determined.

In 370, the attribute value of the target attribute is read based on the determined storage location of the attribute byte group.

In the above manner, in this solution, an attribute value of a specified attribute can be directly read from the graph data stored in the byte group sequence format, without serializing the entire graph data, thereby significantly improving read efficiency of the specified attribute value.

FIG. 4 is a schematic diagram illustrating an example of byte group sequence format 400 according to an embodiment of this specification.

As shown in FIG. 4, byte group sequence format 400 can include byte groups 410, 420, 430, 440, 450, 460, and 470. Byte group 410 can be a null value determining byte group, and data stored in the null value determining byte group can be used to indicate whether data stored in attribute byte groups 420, 430, 440, and 450 is null values. Each attribute byte group can be used to store an attribute value of a specified attribute of graph data. In some examples, types of data stored in the attribute byte groups can be the same or different. In an example, attribute byte groups 420, 430, 440, and 450 can be used to store data of an integer type (int), a character string type (string), a long integer type (long), and a double-precision floating-point type (double) respectively. In some examples, byte group 460 can be a schema identifier byte group, and data stored in the schema identifier byte group can be used to indicate schemas used as a generation basis of the byte group sequence format. In some examples, a length of the schema identifier byte group can be 4 bytes. In some examples, byte group 470 can be an extended byte group. In some examples, extended byte group 470 can be used to store attribute values of a complex data type such as the character string type (string).

In some examples, attribute byte group 430 used to store data of the character string type can be further divided into a data size group and an offset group. The data size group can be used to store a data size of an attribute value corresponding to attribute byte group 430. The offset group can be used to store a start address of storage space occupied by the attribute value corresponding to attribute byte group 430 in extended byte group 470. In some examples, byte group sequence format 400 can further include attribute byte groups used to store data of complex types such as list, data, and point and edge data. These attribute byte groups can also be divided into data size groups and offset groups with reference to the above attribute byte group 430. In some examples, the attribute byte groups can have the same length, for example, 8 bytes.

It can be understood that byte group sequence format 400 shown in FIG. 4 is merely an example. Based on a specific application need, byte group sequence format 400 can involve more or fewer byte groups.

According to the graph data processing methods disclosed in FIG. 1 to FIG. 4, conventional graph data represented in a data object form can be converted into a corresponding byte group sequence format based on types of the graph data, and attribute values of the graph data can be stored in corresponding byte groups in binary formats. Therefore, binary coding of attribute values of various data types of the graph data is implemented. Further, arrangement positions of attributes in the byte group sequence format can be indicated by using schemas corresponding to the types of the graph data, to help efficiently read the corresponding attribute values, thereby avoiding a large amount of conventional shuffle overheads and IO overheads caused by frequent serialization and deserialization of an object.

FIG. 5 is a flowchart illustrating an example of graph database-based data processing method 500 according to an embodiment of this specification.

In 510, an operation statement for a graph database is converted into a corresponding execution plan.

In this embodiment, each piece of graph data in the graph database is stored according to a byte group sequence format that matches the graph data. The byte group sequence format is used to indicate an organization manner of attribute values of the stored graph data, and the attribute values of the stored graph data are represented in binary forms. In some examples, for the graph data stored in the graph database, references can be made to the related descriptions of the above embodiments.

In this embodiment, the operation statement for the graph database can include a statement used to indicate to perform an operation such as addition, deletion, modification, or query on graph data in the graph database. In some examples, the above operation statement can be a Cypher statement, a Gremlin statement, etc.

In 520, the execution plan is executed to obtain an operation result corresponding to the operation statement.

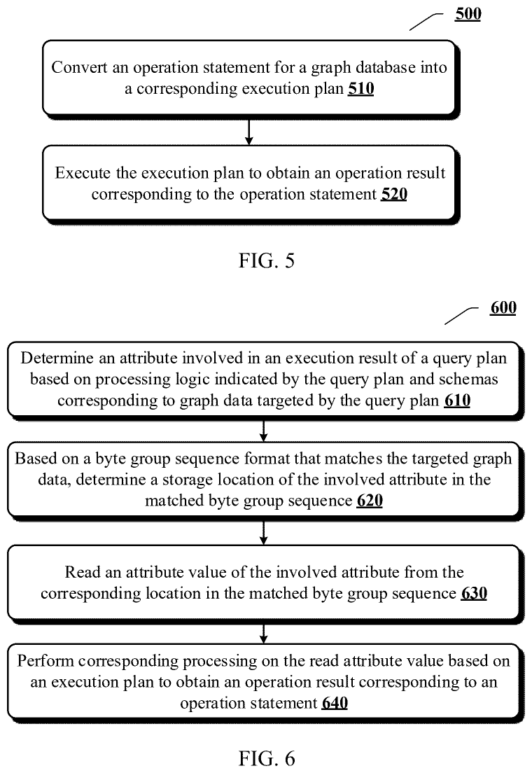

FIG. 6 is a flowchart illustrating an example of execution process 600 of an execution plan according to an embodiment of this specification. In this embodiment, the operation statement can include a query statement. The execution plan can include a query plan. In some examples, the execution plan obtained by converting the query statement can include multiple query plans. In an example, a Gremlin graph query statement can be g.V().values(‘name’). In some examples, the operation statement for the graph database can be converted into the corresponding execution plan by using a data computing engine.

In 610, an attribute involved in an execution result of the query plan is determined based on processing logic indicated by the query plan and schemas corresponding to graph data targeted by the query plan.

In this embodiment, the schemas corresponding to the graph data targeted by the query plan can be used to indicate attributes of the graph data. Then, the attribute involved in the execution result of the query plan can be determined by performing inference based on the processing logic indicated by the query plan. In an example, a schema corresponding to point data targeted by the Gremlin graph query statement g.V().values(‘name’) can be used to indicate three attributes: a name (name), an age (age), and a city (city). Based on processing logic indicated by a query plan corresponding to g.V().values(‘name’), it can be determined that an attribute involved in a point output by values ('name') is a name, and the point does not involve an age or a city. Similarly, for each query plan, an output type obtained after the query plan is executed, i.e. an attribute involved in the query plan, can be determined.

In 620, based on a byte group sequence format that matches the targeted graph data, a storage location of the involved attribute in the matched byte group sequence is determined.

In 630, an attribute value of the involved attribute is read from the corresponding location in the matched byte group sequence.

In some examples, references can be made to the descriptions of step 360 and step 370 in the above embodiments, to read the attribute value of the involved attribute from the corresponding location in the byte group sequence. In an example, for the schema corresponding to the point data in the above example, a byte group sequence format that matches the point data can include attribute byte groups sequentially corresponding to “name”, “age”, and “city”. In this case, an attribute value of the involved attribute (“name”) can be read from the first attribute byte group in the byte group sequence.

In 640, corresponding processing is performed on the read attribute value based on the execution plan to obtain the operation result corresponding to the operation statement.

In some examples, if a query result obtained for the query plan can be used for subsequent computing, when the query result is needed, the read attribute value represented in binary can be directly sent to an execution body of the subsequent computing, until the execution result represented in binary corresponding to the entire execution plan is obtained. The execution result represented in binary can be converted into a corresponding decimal, letter, Chinese character, etc. according to a corresponding binary coding scheme (for example, value conversion, ASCII coding, GB2312 coding, or Unicode coding), and the converted execution result can be determined as the operation result corresponding to the operation statement. In some examples, if the query result obtained for the query plan is provided for a user, the query result represented in binary can be converted into a corresponding decimal, letter, Chinese character, etc. according to a binary coding scheme (for example, value conversion, ASCII coding, GB2312 coding, or Unicode coding) corresponding to the attribute value, and the converted query result can be provided for the user.

Based on this, in this solution, an attribute involved in an execution result of each query plan is first determined, and then a corresponding attribute value is pertinently read from graph data stored in a matched byte group sequence format, thereby further improving data processing efficiency.

According to the graph database-based data processing method disclosed in FIG. 5 and FIG. 6, a data processing method based on graph data stored in a byte group sequence format is provided. Overheads originally caused by frequent serialization and deserialization processes of an object of graph data are greatly reduced in a data processing process, thereby significantly improving data processing efficiency.

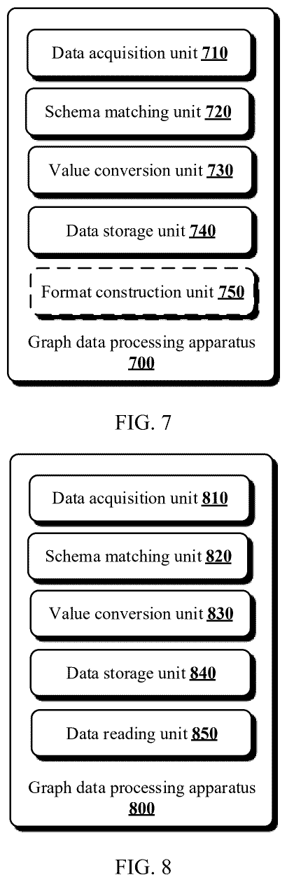

FIG. 7 is a block diagram illustrating an example of graph data processing apparatus 700 according to an embodiment of this specification. This apparatus embodiment can correspond to the method embodiments shown in FIG. 2 to FIG. 4, and the apparatus can be specifically applied to various electronic devices.

As shown in FIG. 7, graph data processing apparatus 700 can include data acquisition unit 710, schema matching unit 720, value conversion unit 730, and data storage unit 740.

Data acquisition unit 710 is configured to obtain graph data represented in a data object form, where the graph data includes type values and attribute values of point and edge data. Schema matching unit 720 is configured to query corresponding schemas based on the type values to determine a number of attribute byte groups corresponding to the type values, where the schemas are used to indicate attributes of the point and edge data, and each attribute byte group is used to store an attribute value of a corresponding attribute.

Value conversion unit 730 is configured to convert the attribute values of the graph data into binary forms.

Data storage unit 740 is configured to store the graph data represented in the binary forms according to a byte group sequence format that matches the number of determined attribute byte groups.

In an example, data storage unit 740 can be further configured to store the attribute values of the graph data that are represented in the binary forms in corresponding attribute byte groups in the byte group sequence format; determine values of data stored in a null value determining byte group in the byte group sequence format based on data stored in the attribute byte groups in the byte group sequence format; and store the determined values in the null value determining byte group.

In an example, data storage unit 740 can be further configured to store schema identifiers in a schema identifier byte group in the byte group sequence format; and store the attribute values of the graph data that are represented in the binary forms in corresponding attribute byte groups in the byte group sequence format.

In an example, graph data processing apparatus 700 can further include format construction unit 750. Format construction unit 750 can be configured to construct the byte group sequence format that matches the number of determined attribute byte groups based on a combination of the null value determining byte group and the number of attribute byte groups, where the data stored in the null value determining byte group is used to indicate whether data stored in the number of attribute byte groups is null.

In an example, the schemas are further used to indicate data type needs of the attributes for corresponding attribute values, and format construction unit 750 can be further configured to construct, based on a data type need corresponding to each attribute byte group in the number of attribute byte groups, a unit byte group that matches the data type need; and construct the byte group sequence format that matches the number of determined attribute byte groups based on a combination of constructed unit byte groups.

In an example, the unit byte group includes at least one of a first data type byte group and a second data type byte group, and format construction unit 750 can be further configured to: if the data type need corresponding to the attribute byte group indicates that an attribute value belongs to a first data type, construct the first data type byte group, where the first data type byte group is used to store an attribute value that belongs to the first data type in the graph data; or if the data type need corresponding to the attribute byte group indicates that an attribute value belongs to a second data type, construct the second data type byte group, where the second data type byte group is used to store storage location information of an attribute value that belongs to the second data type in the graph data.

In an example, first data type byte groups and second data type byte groups have the same length, and an arrangement order of the first data type byte groups and the second data type byte groups is determined based on a sequence of the attributes indicated by the schemas.

In an example, format construction unit 750 can be further configured to: if the constructed unit byte groups include second data type byte groups, construct the byte group sequence format that matches the number of determined attribute byte groups based on a combination of the constructed unit byte groups and an extended byte group, where the extended byte group is used to store attribute values that belong to the second data type in the graph data based on storage location information of the attribute values.

In an example, the schemas corresponding to the type values have the schema identifiers, and format construction unit 750 can be further configured to construct the byte group sequence format that matches the number of determined attribute byte groups based on a combination of the schema identifier byte group and the number of attribute byte groups, where data stored in the schema identifier byte group is used to indicate schemas used as a generation basis of the byte group sequence format.

For operations of data acquisition unit 710, schema matching unit 720, value conversion unit 730, and data storage unit 740, references can be made to the related operations described above in FIG. 2 to FIG. 4.

FIG. 8 is a block diagram illustrating another example of graph data processing apparatus 800 according to an embodiment of this specification. This apparatus embodiment can correspond to the method embodiments shown in FIG. 2 to FIG. 4, and the apparatus can be specifically applied to various electronic devices.

As shown in FIG. 8, graph data processing apparatus 800 can include data acquisition unit 810, schema matching unit 820, value conversion unit 830, data storage unit 840, and data reading unit 850.

Data acquisition unit 810 is configured to obtain graph data represented in a data object form, where the graph data includes type values and attribute values of point and edge data.

Schema matching unit 820 is configured to query corresponding schemas based on the type values to determine a number of attribute byte groups corresponding to the type values, where the schemas are used to indicate attributes of the point and edge data and data type needs of the attributes for corresponding attribute values, and each attribute byte group is used to store an attribute value of a corresponding attribute.

Value conversion unit 830 is configured to convert the attribute values of the graph data into binary forms.

Data storage unit 840 can be further configured to store the attribute values of the graph data that are represented in the binary forms according to a byte group sequence format that matches the number of determined attribute byte groups. The byte group sequence format that matches the number of determined attribute byte groups is constructed in the following manner: if a data type need corresponding to an attribute byte group indicates that an attribute value belongs to a first data type, constructing a first data type byte group, where the first data type byte group is used to store an attribute value that belongs to the first data type in the graph data; or if a data type need corresponding to an attribute byte group indicates that an attribute value belongs to a second data type, constructing a second data type byte group, where the second data type byte group is used to store storage location information of an attribute value that belongs to the second data type in the graph data, first data type byte groups and second data type byte groups have the same length, and an arrangement order of the first data type byte groups and the second data type byte groups is determined based on a sequence of the attributes indicated by the schemas; and constructing the byte group sequence format that matches the number of determined attribute byte groups based on a combination of at least one of the constructed first data type byte groups and second data type byte groups.

Data reading unit 850 is configured to: in response to receiving an attribute value read request for a target attribute of target graph data, determine a target schema that a byte group sequence format used to store the target graph data is based on; determine a storage location of an attribute byte group corresponding to the target attribute in the corresponding byte group sequence format based on the target schema; and read an attribute value of the target attribute based on the determined storage location of the attribute byte group.

For operations of data acquisition unit 810, schema matching unit 820, value conversion unit 830, data storage unit 840, and data reading unit 850, references can be made to the related operations described above in FIG. 2 to FIG. 4.

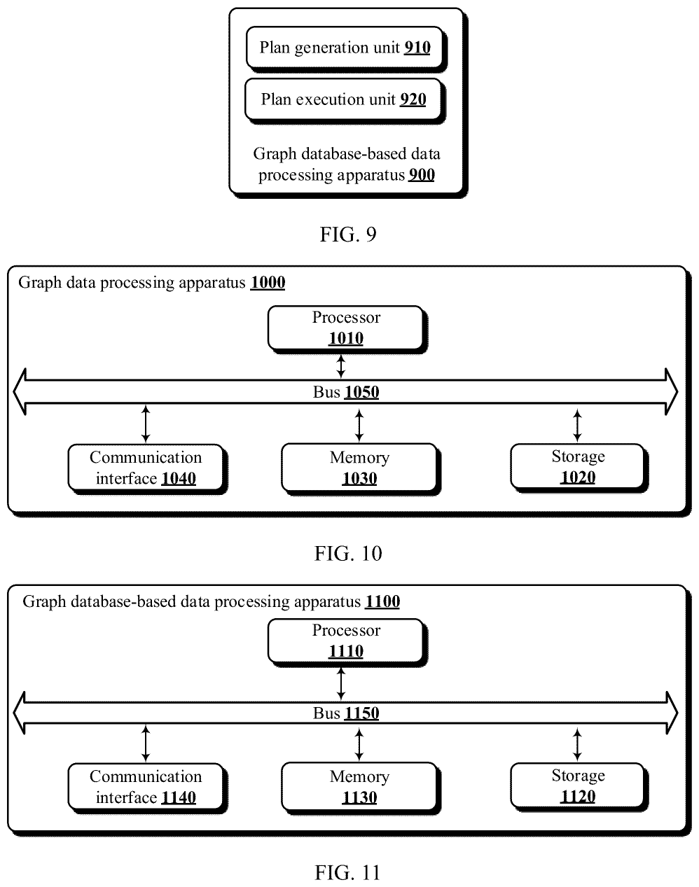

FIG. 9 is a block diagram illustrating an example of graph database-based data processing apparatus 900 according to an embodiment of this specification. This apparatus embodiment can correspond to the method embodiments shown in FIG. 5 and FIG. 6, and the apparatus can be specifically applied to various electronic devices.

As shown in FIG. 9, graph database-based data processing apparatus 900 can include plan generation unit 910 and plan execution unit 920.

Plan generation unit 910 is configured to convert an operation statement for a graph database into a corresponding execution plan, where each piece of graph data in the graph database is stored according to a byte group sequence format that matches the graph data, the byte group sequence format is used to indicate an organization manner of attribute values of the stored graph data, and the attribute values of the graph data are represented in binary forms.

Plan execution unit 920 is configured to execute the execution plan to obtain an operation result corresponding to the operation statement.

In an example, the operation statement includes a query statement, and the execution plan includes a query plan; and plan execution unit 920 can be further configured to determine an attribute involved in an execution result of the query plan based on processing logic indicated by the query plan and schemas corresponding to graph data targeted by the query plan, where the schemas are used to indicate attributes of the graph data; determine, based on a byte group sequence format that matches the targeted graph data, a storage location of the involved attribute in the matched byte group sequence; read an attribute value of the involved attribute from the corresponding location in the matched byte group sequence; and perform corresponding processing on the read attribute value based on the execution plan to obtain the operation result corresponding to the operation statement.

For operations of plan generation unit 910 and plan execution unit 920, references can be made to the above related descriptions in FIG. 5 and FIG. 6.

Embodiments of the graph data processing method and apparatus, and the graph database-based data processing method and apparatus according to the embodiments of this specification are described above with reference to FIG. 1 to FIG. 9.

The graph data processing apparatus and the graph database-based data processing apparatus in the embodiments of this specification can be implemented by using hardware, or can be implemented by using software or a combination of hardware and software. Software implementation is used as an example. As a logical apparatus, the apparatus is formed by reading corresponding computer program instructions from a storage to a memory by a processor of a device that the apparatus is located in. In the embodiments of this specification, the graph data processing apparatus and the graph database-based data processing apparatus can be implemented by using, for example, electronic devices.

FIG. 10 is a schematic diagram illustrating an example of graph data processing apparatus 1000 according to an embodiment of this specification.

As shown in FIG. 10, graph data processing apparatus 1000 can include at least one processor 1010, storage (for example, non-volatile storage) 1020, memory 1030, and communications interface 1040, and at least one processor 1010, storage 1020, memory 1030, and communications interface 1040 are connected together through bus 1050. At least one processor 1010 executes at least one computer readable instruction (the above element implemented in a software form) stored or coded in the storage.

In an embodiment, computer executable instructions are stored in the storage. When the computer executable instructions are executed, at least one processor 1010 is enabled to obtain graph data represented in a data object form, where the graph data includes type values and attribute values of point and edge data; query corresponding schemas based on the type values to determine a number of attribute byte groups corresponding to the type values, where the schemas are used to indicate attributes of the point and edge data, and each attribute byte group is used to store an attribute value of a corresponding attribute; convert the attribute values of the graph data into binary forms; and store the attribute values of the graph data that are represented in the binary forms according to a byte group sequence format that matches the number of determined attribute byte groups.

It should be understood that, when the computer executable instructions stored in the storage are executed, at least one processor 1010 is enabled to perform the various operations and functions described above with reference to FIG. 1 to FIG. 4 in the embodiments of this specification.

FIG. 11 is a schematic diagram illustrating an example of graph database-based data processing apparatus 1100 according to an embodiment of this specification.

As shown in FIG. 11, graph database-based data processing apparatus 1100 can include at least one processor 1110, storage (for example, non-volatile storage) 1120, memory 1130, and communications interface 1140, and at least one processor 1110, storage 1120, memory 1130, and communications interface 1140 are connected together through bus 1150. At least one processor 1110 executes at least one computer readable instruction (the above element implemented in a software form) stored or coded in the storage.

In an embodiment, computer executable instructions are stored in the storage. When the computer executable instructions are executed, at least one processor 1110 is enabled to convert an operation statement for a graph database into a corresponding execution plan, where each piece of graph data in the graph database is stored according to a byte group sequence format that matches the graph data, the byte group sequence format is used to indicate an organization manner of attribute values of the stored graph data, and the attribute values of the graph data are represented in binary forms; and execute the execution plan to obtain an operation result corresponding to the operation statement.

It should be understood that, when the computer executable instructions stored in the storage are executed, at least one processor 1110 is enabled to perform the various operations and functions described above with reference to FIG. 5 and FIG. 6 in the embodiments of this specification.

According to an embodiment, a program product such as a computer readable medium is provided. The computer readable medium can have instructions (the above element implemented in a software form). When the instructions are executed by a computer, the computer is enabled to perform the various operations and functions described above with reference to FIG. 1 to FIG. 6 in the embodiments of this specification.

Specifically, a system or an apparatus that a readable storage medium is configured in can be provided. Software program code implementing a function in any one of the above embodiments is stored in the readable storage medium, and a computer or a processor of the system or the apparatus is enabled to read and execute instructions stored in the readable storage medium.

In this case, the program code read from the readable medium can implement the function in any one of the above embodiments. Therefore, the machine readable code and the readable storage medium that stores the machine readable code form a part of this specification.

Computer program code needed for operation of each part of this specification can be compiled in any one or more programming languages, including object-oriented programming languages such as Java, Scala, Smalltalk, Eiffel, JADE, Emerald, C++, C#, VB, NET, and Python, conventional programming languages such as a C language, Visual Basic 2003, Perl, COBOL 2002, PHP, and ABAP, dynamic programming languages such as Python, Ruby, and Groovy, or other programming languages. The program code can run on a user computer, or run as a standalone software package on the user computer, or partially run on the user computer and partially run on a remote computer, or completely run on the remote computer or a server. In the latter case, the remote computer can be connected to the user computer in any form of network, such as a local area network (LAN) or a wide area network (WAN), or connected to an external computer (through, for example, the Internet), or in a cloud computing environment, or used as a service, such as software as a service (SaaS).

Embodiments of the readable storage medium include a floppy disk, a hard disk, a magneto-optical disk, an optical disc (such as a CD-ROM, a CD-R, a CD-RW, a DVD-ROM, a DVD-RAM, a DVD-R, and a DVD-RW), a magnetic tape, a non-volatile memory card, and a ROM. Alternatively, the program code can be downloaded from a server computer or cloud through a communication network.

Particular embodiments of this specification are described above. Other embodiments are within the scope of the appended claims. In some situations, the actions or steps recorded in the claims can be performed in an order different from the order in the embodiments and the desired results can still be achieved. In addition, the process depicted in the accompanying drawings does not necessarily need the shown particular order or sequence to achieve the desired results. In some implementations, multi-tasking processing and parallel processing are feasible or may be advantageous.

Not all the steps and the units in the above procedures and system structure diagrams are needed. Some steps or units can be ignored based on an actual need. An execution sequence of the steps is not fixed, and can be determined based on a need. The apparatus structure described in the above embodiments can be a physical structure, or can be a logical structure, i.e. some units can be implemented by the same physical entity, or some units can be implemented by multiple physical entities, or can be jointly implemented by some components in multiple independent devices.

The term “example” used throughout this specification means “used as an example, an instance, or an illustration” and does not mean “preferred” or “advantageous” over other embodiments. Specific implementations include specific details for the purpose of providing an understanding of the described technologies. However, these technologies can be implemented without these specific details. In some examples, well-known structures and apparatuses are shown in block diagrams in order to avoid making it difficult to understand the concepts of the described embodiments.

Optional implementations of the embodiments of this specification are described above in detail with reference to the accompanying drawings. However, the embodiments of this specification are not limited to specific details in the above implementations. Within a technical concept scope of the embodiments of this specification, a plurality of simple variations can be made to the technical solutions in the embodiments of this specification, and these simple variations all fall within the protection scope of the embodiments of this specification.

The above descriptions of the content in this specification are provided to enable any person of ordinary skill in the art to implement or use the content in this specification. It is clear to a person of ordinary skill in the art that various modifications can be made to the content in this specification. In addition, the general principle described in this specification can be applied to another variant without departing from the protection scope of the content in this specification. Therefore, the content in this specification is not limited to the examples and designs described in this specification, but is consistent with the widest range of principles and novelty features that conform to this specification.

1. A graph data processing method, comprising:
obtaining graph data represented in a data object form, wherein the graph data comprises type values and attribute values of point and edge data;
querying corresponding schemas based on the type values to determine a number of attribute byte groups corresponding to the type values, wherein the schemas are used to indicate attributes of the point and edge data, and each attribute byte group is used to store an attribute value of a corresponding attribute;
converting the attribute values of the graph data into binary forms; and
storing the attribute values of the graph data that are represented in the binary forms according to a byte group sequence format that matches the number of determined attribute byte groups.

2. The graph data processing method according to claim 1, wherein the byte group sequence format that matches the number of determined attribute byte groups is constructed in the following manner:
constructing the byte group sequence format that matches the number of determined attribute byte groups based on a combination of a null value determining byte group and the number of attribute byte groups, wherein data stored in the null value determining byte group is used to indicate whether data stored in the number of attribute byte groups is null.

3. The graph data processing method according to claim 2, wherein the storing the attribute values of the graph data that are represented in the binary forms according to a byte group sequence format that matches the number of determined attribute byte groups comprises:
storing the attribute values of the graph data that are represented in the binary forms in corresponding attribute byte groups in the byte group sequence format;
determining values of the data stored in the null value determining byte group in the byte group sequence format based on data stored in the attribute byte groups in the byte group sequence format; and
storing the determined values in the null value determining byte group.

4. The graph data processing method according to claim 1, wherein the schemas are further used to indicate data type needs of the attributes for corresponding attribute values; and
the byte group sequence format that matches the number of determined attribute byte groups is constructed in the following manner:
constructing, based on a data type need corresponding to each attribute byte group in the number of attribute byte groups, a unit byte group that matches the data type need; and
constructing the byte group sequence format that matches the number of determined attribute byte groups based on a combination of constructed unit byte groups.

5. The graph data processing method according to claim 4, wherein the unit byte group comprises at least one of a first data type byte group and a second data type byte group, and the constructing, based on a data type need corresponding to each attribute byte group in the number of attribute byte groups, a unit byte group that matches the data type need comprises:
if the data type need corresponding to the attribute byte group indicates that an attribute value belongs to a first data type, constructing the first data type byte group, wherein the first data type byte group is used to store an attribute value that belongs to the first data type in the graph data; or
if the data type need corresponding to the attribute byte group indicates that an attribute value belongs to a second data type, constructing the second data type byte group, wherein the second data type byte group is used to store storage location information of an attribute value that belongs to the second data type in the graph data.

6. The graph data processing method according to claim 5, wherein the constructing the byte group sequence format that matches the number of determined attribute byte groups based on a combination of constructed unit byte groups comprises:
if the constructed unit byte groups comprise a second data type byte group, constructing the byte group sequence format that matches the number of determined attribute byte groups based on a combination of the constructed unit byte groups and an extended byte group, wherein the extended byte group is used to store attribute values that belong to the second data type in the graph data based on storage location information of the attribute values.

7. The graph data processing method according to claim 5, wherein the first data type byte group and the second data type byte group have the same length, and an arrangement order of the first data type byte group and the second data type byte group is determined based on a sequence of the attributes indicated by the schemas.

8. The graph data processing method according to claim 7, further comprising:
in response to receiving an attribute value read request for a target attribute of target graph data, determining a target schema that a byte group sequence format used to store the target graph data is based on;
determining a storage location of an attribute byte group corresponding to the target attribute in the corresponding byte group sequence format based on the target schema; and
reading an attribute value of the target attribute based on the determined storage location of the attribute byte group.

9. The graph data processing method according to claim 1, wherein the schemas corresponding to the type values have schema identifiers; and
the byte group sequence format that matches the number of determined attribute byte groups is constructed in the following manner:
constructing the byte group sequence format that matches the number of determined attribute byte groups based on a combination of a schema identifier byte group and the number of attribute byte groups, wherein data stored in the schema identifier byte group is used to indicate schemas used as a generation basis of the byte group sequence format.

10. The graph data processing method according to claim 9, wherein the storing the attribute values of the graph data that are represented in the binary forms according to a byte group sequence format that matches the number of determined attribute byte groups comprises:
storing the schema identifiers in the schema identifier byte group in the byte group sequence format; and
storing the attribute values of the graph data that are represented in the binary forms in corresponding attribute byte groups in the byte group sequence format.

11-14. (canceled)

15. A graph data processing apparatus, comprising at least one processor, a storage coupled to the at least one processor, and a computer program stored in the storage, which when executed by the at least one processor causes the graph data processing apparatus to:
obtain graph data represented in a data object form, wherein the graph data comprises type values and attribute values of point and edge data;
query corresponding schemas based on the type values to determine a number of attribute byte groups corresponding to the type values, wherein the schemas are used to indicate attributes of the point and edge data, and each attribute byte group is used to store an attribute value of a corresponding attribute;
convert the attribute values of the graph data into binary forms; and
store the attribute values of the graph data that are represented in the binary forms according to a byte group sequence format that matches the number of determined attribute byte groups.

16. (canceled)

17. The graph data processing apparatus according to claim 15, wherein the byte group sequence format that matches the number of determined attribute byte groups is constructed in the following manner:
constructing the byte group sequence format that matches the number of determined attribute byte groups based on a combination of a null value determining byte group and the number of attribute byte groups, wherein data stored in the null value determining byte group is used to indicate whether data stored in the number of attribute byte groups is null.

18. The graph data processing apparatus according to claim 17, wherein the graph data processing apparatus being caused to store the attribute values of the graph data that are represented in the binary forms according to a byte group sequence format that matches the number of determined attribute byte groups comprises being caused to:
store the attribute values of the graph data that are represented in the binary forms in corresponding attribute byte groups in the byte group sequence format;
determine values of the data stored in the null value determining byte group in the byte group sequence format based on data stored in the attribute byte groups in the byte group sequence format; and
store the determined values in the null value determining byte group.

19. The graph data processing apparatus according to claim 15, wherein the schemas are further used to indicate data type needs of the attributes for corresponding attribute values; and
the byte group sequence format that matches the number of determined attribute byte groups is constructed in the following manner:
constructing, based on a data type need corresponding to each attribute byte group in the number of attribute byte groups, a unit byte group that matches the data type need; and
constructing the byte group sequence format that matches the number of determined attribute byte groups based on a combination of constructed unit byte groups.

20. The graph data processing apparatus according to claim 19, wherein the unit byte group comprises at least one of a first data type byte group and a second data type byte group, and the constructing, based on a data type need corresponding to each attribute byte group in the number of attribute byte groups, a unit byte group that matches the data type need comprises:
if the data type need corresponding to the attribute byte group indicates that an attribute value belongs to a first data type, constructing the first data type byte group, wherein the first data type byte group is used to store an attribute value that belongs to the first data type in the graph data; or
if the data type need corresponding to the attribute byte group indicates that an attribute value belongs to a second data type, constructing the second data type byte group, wherein the second data type byte group is used to store storage location information of an attribute value that belongs to the second data type in the graph data.

21. A non-transitory computer-readable storage medium storing instructions, wherein the non-transitory computer-readable storage medium stores a computer program, which when executed by a processor causes the processor to:
obtain graph data represented in a data object form, wherein the graph data comprises type values and attribute values of point and edge data;
query corresponding schemas based on the type values to determine a number of attribute byte groups corresponding to the type values, wherein the schemas are used to indicate attributes of the point and edge data, and each attribute byte group is used to store an attribute value of a corresponding attribute;
convert the attribute values of the graph data into binary forms; and
store the attribute values of the graph data that are represented in the binary forms according to a byte group sequence format that matches the number of determined attribute byte groups.

22. The non-transitory computer-readable storage medium according to claim 21, wherein the byte group sequence format that matches the number of determined attribute byte groups is constructed in the following manner:
constructing the byte group sequence format that matches the number of determined attribute byte groups based on a combination of a null value determining byte group and the number of attribute byte groups, wherein data stored in the null value determining byte group is used to indicate whether data stored in the number of attribute byte groups is null.

23. The non-transitory computer-readable storage medium according to claim 22, wherein the processor being caused to store the attribute values of the graph data that are represented in the binary forms according to a byte group sequence format that matches the number of determined attribute byte groups comprises being caused to:
store the attribute values of the graph data that are represented in the binary forms in corresponding attribute byte groups in the byte group sequence format;
determine values of the data stored in the null value determining byte group in the byte group sequence format based on data stored in the attribute byte groups in the byte group sequence format; and
store the determined values in the null value determining byte group.

24. The non-transitory computer-readable storage medium according to claim 21, wherein the schemas are further used to indicate data type needs of the attributes for corresponding attribute values; and
the byte group sequence format that matches the number of determined attribute byte groups is constructed in the following manner:
constructing, based on a data type need corresponding to each attribute byte group in the number of attribute byte groups, a unit byte group that matches the data type need; and
constructing the byte group sequence format that matches the number of determined attribute byte groups based on a combination of constructed unit byte groups.

25. The non-transitory computer-readable storage medium according to claim 24, wherein the unit byte group comprises at least one of a first data type byte group and a second data type byte group, and the constructing, based on a data type need corresponding to each attribute byte group in the number of attribute byte groups, a unit byte group that matches the data type need comprises:
if the data type need corresponding to the attribute byte group indicates that an attribute value belongs to a first data type, constructing the first data type byte group, wherein the first data type byte group is used to store an attribute value that belongs to the first data type in the graph data; or
if the data type need corresponding to the attribute byte group indicates that an attribute value belongs to a second data type, constructing the second data type byte group, wherein the second data type byte group is used to store storage location information of an attribute value that belongs to the second data type in the graph data.
